(19) United States
(12) Patent Application Publication
(10) Pub. No.: US 2009/0131089 A1
(43) Pub. Date: May 21, 2009

(54) Personal text trainer system for sound diets and fitness regimens

(76) Inventors: Anthony Micali, Lynbrook, NY (US); Christopher Licausi, Elmont, NY (US)

Correspondence Address: Anthony Micali, 107 Canterbury Gate, Lynbrook, NY, 11563, US

(21) Appl. No.: 12/291,953

(22) Filed: Nov. 14, 2008

Related U.S. Application Data
(60) Provisional application No. 61/003,302, filed on Nov. 16, 2007.

(51) Int. Cl. H04W 4/12

(52) U.S. Cl. 455/466

(57) ABSTRACT

A computer based personal trainer system and method for maintaining a diet and fitness regimen to improve overall health of the person and support the person to adhere to the diet and fitness regimen for predefined duration of times. An interested person subscribes to the service by sending a short request text message with a mobile phone device. Primary profile, diet, and fitness profile, and personal preferences of the subscriber are updated and maintained in a database of the system. The database also includes a plurality of compiled diet information, fitness, and motivational messages. The system has a main server that has a plurality of applications that process the subscriber requests and sends appropriate data to the cell phone of the subscriber.

### RELATED APPLICATIONS

This application claims priority of U.S. Ser. No. 61/003,302 provisional application, filed Nov. 16, 2007.

### BACKGROUND OF THE INVENTION

1. Field of the Invention

The present invention is related to personal electronic communication system to encourage and facilitate an individual's adherence to sound diets and fitness regimes. Background of the invention

2. Description of the Prior Art

According to the existing medical research, fewer than five percent of all dieters succeed in losing a significant amount of weight and maintaining that weight loss over a five-year period. The successful adherence to diet and exercise regimens and, as such, an individual's achievement of his or her personal fitness objectives, is contingent upon the individual's ability to remain interested, motivated and challenged. Moreover, individuals require the information necessary to make appropriate diet and exercise decisions that advance the individual's fitness objectives.

Studies show that the reason most people fail at dieting is because they become bored and lazy. An average individual generally fails to continue a diet and fitness regimen for a substantial period of time. People lose interest with continued diet regimens due to lack of follow up and information about dieting and nutrition. A daily diet plan is not available to people to continue with the regimen. If the daily plan is available it is usually not accessible all the time because it is either on paper or a plan is missed somewhere in routine work.

People interested in dieting and fitness need a lot of motivation to continue with the diet and fitness plan after a successful start. Sometimes, interested people have no information about the recipe of a recommended food. People need coaching to carry out the recommended exercise. But they need a coach who is available all the time as and when required by them. People also need diet and fitness information fast and efficiently while going about their daily lives.

There is a need for a personal trainer that teaches nutritional diet and workout, which provides a daily diet workout plan that is with the individual all the time. A trainer is needed that reminds an individual about various activities in daily diet workout plans, motivates the individual to adhere to the regimen, explains recipe and preparation of recommended diet, and teaches a method of carrying out recommend exercises.

### SUMMARY OF THE INVENTION

A computer based personal trainer system and method for maintaining a diet and fitness regimen is described. The present invention discloses a method for personal diet and fitness training to improve overall health of the person and support the person to adhere to the diet and fitness regimen for predefined duration of times.

An interested person subscribes to the service by sending a short request text message with a mobile phone device. Primary profile, diet, and fitness profile, and personal preferences of the subscriber are updated and maintained in a database of the system. The database also includes a plurality of compiled diet information, fitness, and motivational messages. The system has a main server that has a plurality of applications that process the subscriber requests and sends appropriate data to the cell phone of the subscriber. The subscriber may also access messages by accessing personal account over the internet.

After registration with the system of the present invention, the subscriber receives short text message as per predefined schedule preferred by the subscriber. The subscriber receives daily diet and fitness plans. The subscriber also receives subsequent reminders and motivational text messages throughout the day as per predefined time schedule. The subscriber receives the messages through the diet and fitness profile, fitness goods, weather conditions, medications, history and lifestyle of the subscriber. The diet and fitness plan and related information travels with the subscriber throughout the day supporting the subscriber to stay on track and achieve diet and fitness goals.

Through the use of specific algorithms, the computer based system distributes one or more of the aforementioned types of messages to the subscriber based upon the specific information based submitted by the individual subscriber. The computer-based system disseminates the appropriate information based upon the appropriate algorithm and effectuates the subscriber's payment. The subscriber has options to unsubscribe the service by sending a request to stop the service in a predefined text message.

### BRIEF DESCRIPTION OF THE DRAWINGS

FIG. 1 shows a conceptual illustration of the diet and fitness personal text trainer system of the present invention;

FIG. 2 shows a modular representation the diet and fitness personal text trainer system of the present invention;

FIG. 3 is a flowchart that shows steps involved in a method of subscribing the service of present invention; and

FIG. 4 shows a flowchart that shows steps involved in a method of creating a diet and fitness profile of a subscriber of the present invention.

### DETAILED DESCRIPTION OF THE PREFERRED EMBODIMENTS

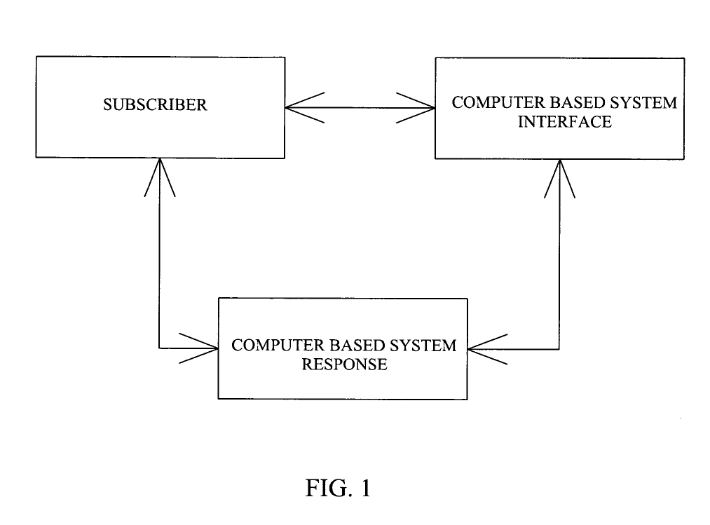

Referring to FIG. 1, a simple illustration of a personal text trainer system of the present invention is shown. An interested person submits a request to subscribe the service of the personal text trainer system by sending a request text message. The subscriber submits personal information and payment information for the service with a predefined interface of the computer based personal trainer system.

The computer based system uses appropriate algorithm to disseminate the requested information to the subscriber preferably by text messaging to the subscriber's cell phone device. The system also takes care of the payment of the service charges preferably by adding the service charges in a monthly phone bill of the subscriber. The subscriber cancels the service by sending a predefined text message request to a predefined number.

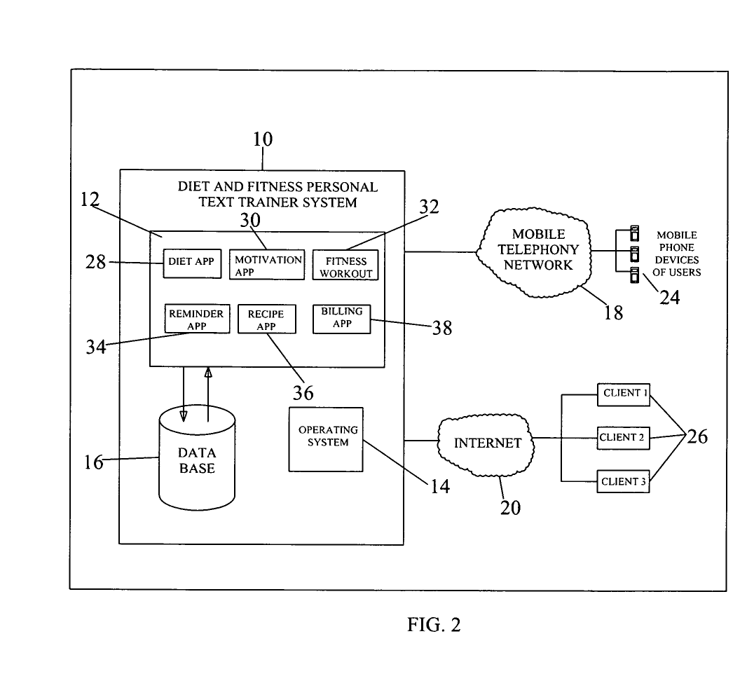

Referring to FIG. 2, computer-based personal text trainer system 10 includes a main server 12, operating system 14, database 16, mobile telephony network 18, internet 20, mobile client 24 and computer clients 26. The system interfaces include a mobile telephony network 18 and an internet 20. A plurality of application programs run on the main server 12. The application programs are preferably based on predefined algorithms that execute respective applications.

The server 12 receives requests from client 24 that is preferably a mobile device of a user. Server 12 sends the request to the database 16 to fetch required information. The server 12 receives the requested information from the database 16. The data is sent to respective mobile clients 24 using text messages. The text messages are sent to the clients 24 through predefined networks, for example, GSM network that is well known in the art. The applications that run on the main server 12 select pre-compiled text messages according to the user profile and send the text messages to the user.

A plurality of predefined application programs runs on the server that include a diet application 28, motivational application 30; fitness and workout application 32, reminders application 34, recipe application 36, and billing application 38. Each of these applications selects predefined text messages in the database 16 and sends one or more text messages to respective users. These text messages are posted to the user's mobile device via mobile network 18. The text messages are selected according to the profile, preferences, schedules set by the user.

Database 16 stores complete data required by the system 10 that includes subscriber accounts, subscriber personal details, billing information, dieting and fitness data, precompiled messages, recipes, workout plans etc. The database 16 is in communication with the main server 12. The user information that forms a profile is preferably submitted to the system 10 by sending text messages with a mobile handset device of an interested person. A subscriber/interested person updates respective personal details and diet-fitness profile by using an identification code or login code.

Subscribers access main server 12 through mobile telephone network 18 with respective personal mobile phone devices. Subscribers also access the main server 12 with one or more computer systems through internet 20. Subscribers communicate with the system server 12 by sending text messages in a predefined format. The user may also communicate with the computer server 12 via internet 20 after the user is registered by text messaging to the system 10. The user preferably receives an identification code or login code or a registration code for accessing the system 10.

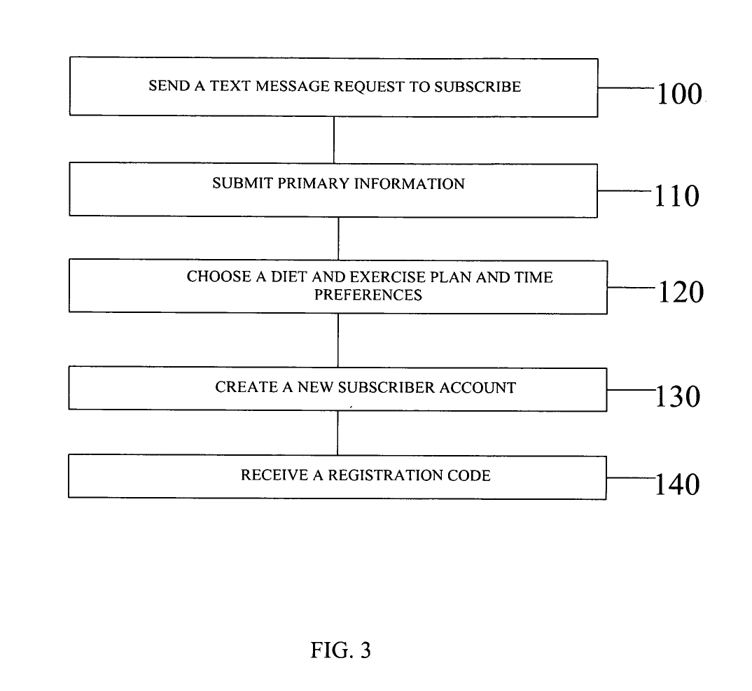

Referring to FIG. 3, a method to subscribe to the personal text trainer system 10 of the present invention is described. An individual subscribes to the diet and fitness personal text trainer system 10 of the present invention to follow and maintain sound diet and fitness regimens. In a first step 100, an interested person initiates a process of subscription to the personal trainer system 10 preferably by sending a predefined request text message to a predefined number using a personal mobile cell phone device in the step 100.

In this step, the interested individual subscribes to the service of personal trainer system 10 by sending, for example, a text message ‘START REGZMEN’ to 5555 with a personal mobile phone device. In a next step 110, the subscriber submits primary information. In this step, the subscriber receives a text message requesting for primary information of the user. The text message requests the user to submit details, for example, name, age, gender, and location. In this step, the subscriber submits primary information by sending the information in a text message.

In step 120, the user chooses diet and fitness plans and time preferences. In this step, the subscriber receives a request message to choose a diet and fitness plan out of various diet and exercise plans that are offered in the text message. A plurality of suitable plans is offered by the text trainer system 10 for maintaining diet and fitness regimen to the user in step 120. The plans are, for example, Get skinny, Get ripped-toned, and Get Mass/Jacked. In step 120, the user sends the choice of plan and time preference by a text message.

In step 130, a new account of the subscriber is created in the system 10. The individual receives a congratulations message to confirm the subscription as soon as the monetary transaction is completed. In step 140, a subscribed person receives a registration code or an identification code. The identification code is used to access the account in the system over a telephone line, internet etc. In this step, the subscriber also receives a password for access through internet and telephone by another text message.

The process of subscription is completed on a priority basis after a text message for request of subscription of the service is received. An interested individual also has the option to subscribe to the service through the internet. The interested person preferably pays the subscription charges through the monthly mobile phone bill. It is, however, understood that the interested person may select another modes of payment, for example, by credit card or check.

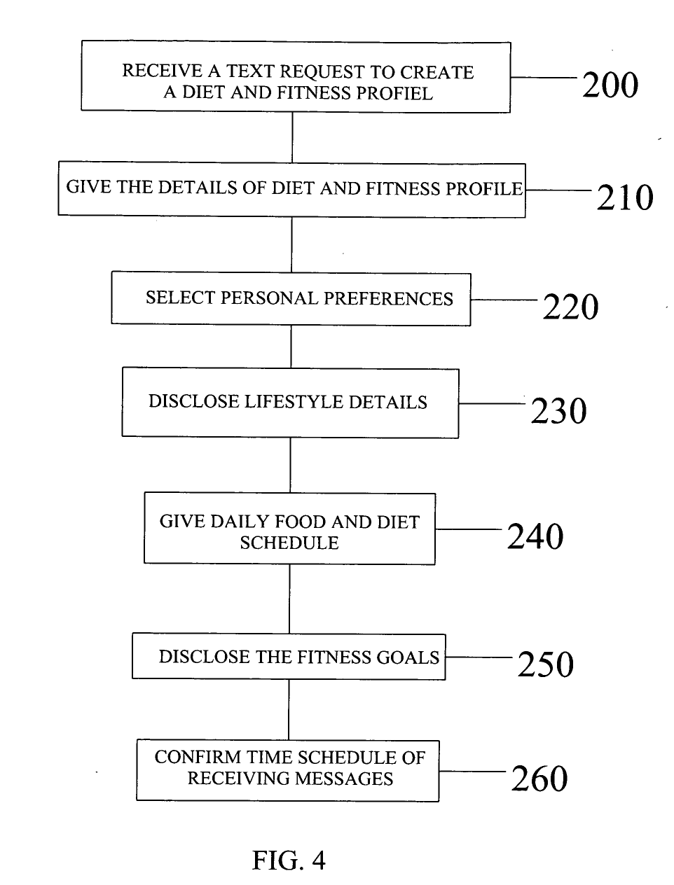

Referring to FIG. 4, a method of creating a diet and fitness profile of the subscriber is described. The method of creating the diet and fitness profile preferably includes collection of a plurality of details of the subscribed user to recommend suitable diet and exercise to the subscriber. The details of the diet and fitness profile are preferably stored in a plurality of predefined fields in the database.

In a first step 200, the subscriber receives a text message to create a diet and fitness profile. The subscriber is requested to submit a plurality of details of the subscriber to create a diet and fitness profile of the subscriber. The diet and fitness profile preferably includes details of height, weight, age, individual habits, health issues, medical history, medical treatments, allergic reactions, recent issues, doctors, alternate phone numbers, and geographic location of the user.

In step 210, the subscriber sends the required details by a text message. The details of diet and fitness profile of the user are updated in the system. The user provides the above mentioned details to update the diet and fitness profile of the subscriber. In this step, the user has the option to submit at least one detail to create the profile. The user has the option to update the diet and fitness profile at another point of time as per the availability, over the internet or by sending details by text messages.

In step 220, the user selects personal preferences. The user is requested to select personal preferences by a text message, to define the diet plan of the user. In this step, the user submits personal preferences, likes, dislikes, and limitations by sending a text message to the system 10.

In a step 230, the subscriber discloses lifestyle details. The subscriber is requested to discloses lifestyle details, for example, personal interests, hobbies, favorite pass time etc. that are used to decide the orientation of the motivational messages that are sent to the subscriber. The subscriber submits the lifestyle details by sending the details in a text message.

In the next step 240, the subscriber submits daily food and diet schedule. The subscribed user is requested to submit information of daily food and diet schedule. The information includes preferred timings of breakfast, lunch, dinner and any other refreshments. In this step the user sends the diet and food schedule by a text message to the system 10. The daily food schedule is updated in the database and is used to send the daily diet text plan per the schedule.

In a next step 250, the subscriber discloses fitness goals. The subscriber receives a text message to disclose the fitness goals, for example, weight reduction by 5 pounds or weight gain by 5 pounds etc. In this step, the user gives details of the fitness goals that the user has fixed for him. The recommendations of diet and exercise plans are set according to the goals of the user. It is, however, understood that the user has an option to input the information of the personal profile via internet or by filling a paper form and submitting it by mail.

In a next step 260, the subscriber selects time to receive text messages from the system 10. The subscriber receives a text message to confirm various times and convenience of receiving the text messages. In this step, the subscriber confirms various times and convenience of receiving text and video messages delivered by the system of the present invention by sending a text message to system 10. In this step, the time schedule for receiving text messages is confirmed.

In operation, the subscriber after creating diet and fitness profile receives a new daily diet plan and a few motivational messages throughout the day from the next day. A list of healthy snack ideas, fat facts are also sent to the subscriber by text messages. In the morning, the user receives a first text message that includes a diet and workout plan for that particular day. The workout plan includes recommended exercise for the day at recommended times. The diet information includes recommended food breakfast, lunch, refreshment, and dinner.

The subscriber receives text message before every scheduled food intake and workout and exercise. The text messages give more details about the respective activity and remind the user about the diet and workout plan. For example, recommended food for lunch by a text message is boiled vegetables 200 gm, and one piece of bread. The subscriber receives such a message before lunch time that makes the subscriber remember the recommended food, and the time. The act of sending text of recommended foods helps the subscriber to adhere to the diet and fitness regimen.

The subscriber may not know a recipe of one or more dishes recommended in the diet plan. The subscriber has the option to request the detailed recipe and method of carrying out the recommended exercise in the workout plan by a text or a video message. For example, the user is recommended a dish Bumese Veg Curry for dinner and the user doesn't know the predation and ingredient of the dish.

In such case, the subscriber may send text message “RECIPE BWS VEG CURRY” to 555, to have the entire recipe text messaged to the user's cell phone device. The recipe is stored in the user's mobile phone device for future reference also. The subscriber has the option to receive a video message to understand the details of the diet and workout plan.

The subscriber also receives motivational, humorous, interesting facts, goal reminders through the text messages for motivating the user to adhere to the diet and fitness regimen. The personal text trainer system is capable of receiving, maintaining and processing personal information submitted by the user and disseminating the requested diet and fitness information including personal encouragement, anecdotes, humorous and motivational messages, dietary and exercise suggestions, recipes and other related information over mobile telephony networks and the internet.

Such disseminated information is delivered via text messaging to cellular telephones, two-way pagers and other similar devices via text messaging and email to internet users on both mobile and fixed devices capable of accessing email correspondence. The present invention describes a system through which individuals subscribe to a service that advantageously encourages and facilitates adherence to sound diet and fitness regimens. The motivational text message preferably sends encouragement, anecdotes, humorous and motivational texts to the user to maintain and to adhere to the diet and fitness regimen.

An interested person subscribes the system 10 by sending text message with a mobile phone device. Once the account is created, the diet and fitness profile is created by text messaging. The diet and fitness profile is created by providing at least one requested detail by text message. This text message acts as a permission to create the profile. Once the diet and fitness profile is created, the subscriber may access the system via text messaging or over the internet. The subscriber may update his/her incomplete profile or change the previously given details by accessing the account in the system over the internet.

After signing via text the subscriber has an option to use the identification code to log in to the system 10 over the internet 20 to view updates, change personal preferences, personal weaknesses etc. The user posts questions or queries to the system 10 by sending text messages or by accessing system over internet 20. Answers to the questions are sent to the user via text messages as well as emails.

The subscriber has the option to stop the personal text trainer service by sending a predefined test message request to the server 12. The registered subscriber may access the system through internet or a phone or a mobile phone by using the registration/identification code and the password to logon to the subscriber account. It is, however, understood that the password can be reset as and when needed by the subscriber.

The method of the present invention is very convenient and cost effective. People always have their cell phones on them at all times, whether at work, at home or on the go. The present invention discloses a simplest method to request and receive diet plans, recipes, and motivational messages at any time throughout the day without even having to turn on a computer or waste a second of their daily schedule.

Once a user is signed up via text message, the diets and motivational messages will be sent to the subscriber everyday automatically without the need of sending another text messages. The reception of text messages is stopped if the subscriber stops the service via text message once again.

A new diet and fitness plan is sent to the subscriber's cell phone every day that promotes speeding up the subscriber's metabolism. A new diet plan every day advantageously keeps the person interested as to what the next text will encompass. The subscribers receive a predetermined number of motivational messages preferably based on the subscriber preferences, lifestyle, likes, hobbies, need etc. All the text messages sent to the subscriber up to the date are available in the account of the subscriber. The subscriber can see all the text messages received on the mobile device in the past by accessing the account over internet.

Every individual checks his or her phone when they receive a text message. It takes two seconds to read and remind to stay on track with a diet regimen or have received a motivational message that will carry the subscriber throughout the remainder of that day. The fees for the service are preferably extremely minimal and preferably appear on monthly phone bill statements of the subscriber.

It is understood that the above are illustrative embodiments and that the present invention is not limited to these embodiments. The present invention includes any communications network between a subscriber and a service that provides for a computer based personal trainer system and method for maintaining a diet and fitness to improve overall health of the person and support the person to adhere to the diet and fitness regimen for predefined duration of times.

The subscriber can, through a communications mode, subscribe to the service to anyone in a variety ways including but not limited to sending a short request text message with a mobile phone device or alternatively using a landline telephone. Primary profile, diet, and fitness profile, and personal preferences of the subscriber are updated and maintained in a database of the system. The database also includes a plurality of compiled diet information, fitness, and motivational messages.

The system has a main server that has a plurality of applications that process the subscriber requests and sends appropriate data by a communications portal, such as, but not limited to the cell phone of the subscriber. The subscriber may also receive messages by accessing personal account through a communications portal, such as, but not limited to over the internet.

After registration with the system of the present invention, the subscriber receives message, such as, but not limited to short text message as per predefined schedule preferred by the subscriber. The subscriber receives daily diet and fitness plans. The subscriber also receives subsequent reminders and motivational messages, such as, but not limited to text messages throughout the day as per predefined time schedule. However, it is understood that the subscriber may request to stop the reminders and motivational text messages by sending a predefined text message to a predefined number.

The reception of reminder and motivational text can be stopped by accessing the account over the internet. An interested person subscribes by sending a text message to the system. The subscriber can update his/her profile, and set preferences over the internet or by text messaging.

The subscriber receives the messages according to the diet and fitness profile, fitness goods, weather conditions, medications, history and lifestyle of the subscriber. The diet and fitness plan and related information travels with the subscriber throughout the day supporting the subscriber to stay on track and achieve diet and fitness goals.

Through the use of specific algorithms, the computer based system distributes one or more of the aforementioned types of messages to the subscriber based upon the specific information based submitted by the individual subscriber. The computer-based system disseminates the appropriate information based upon the appropriate algorithm and effectuates the subscriber's payment. The subscriber has options to unsubscribe to the service by sending a request to stop the service in a message, such as, but not limited to a predefined text message.

The embodiments of the invention shown and discussed herein are merely illustrative of modes of application of the present invention. Reference to details in this discussion is not intended to limit the scope of the claims to these details, or to the figures used to illustrate the invention.

What is claimed is:

1. A method for personal training and maintaining a diet and fitness regimen by sending text messages to a mobile phone device of a subscriber, the steps comprising:
subscribing a diet and fitness personal trainer using a mobile phone device through a mobile telephony network;
creating a diet and fitness profile of the subscriber;
receiving messages of a new daily diet and fitness plan throughout a day on the subscriber's mobile phone device over the mobile telephone network at predefined time hours;
receiving video messages of work out, exercise and recipe to the subscriber's mobile phone device over the mobile telephone network; and
receiving motivational messages on the subscriber's mobile phone device over the mobile telephone network, said motivational messages are for encouraging the subscriber to adhere to the diet and fitness regimen;
receiving a plurality of requests from the subscriber to provide requested information in text messages; and
receiving a request for unsubscribing to the trainer's service by sending a predefined text message request.

2. The method of claim 1, wherein the step of subscribing a diet and fitness personal trainer further comprises:
sending a text message request for subscription;
submitting primary information;
choosing a diet and exercise plan and time preference;
creating a new subscriber account; and
receiving a registration code.

3. The method of claim 1, wherein the step of creating a diet and fitness profile further comprises:
receiving a request text message to create diet and fitness profile;
sending the details of diet and fitness profile;
selecting personal preferences;
disclosing lifestyle details;
giving daily food and diet schedule;
disclosing fitness goals; and
confirming time schedule of receiving text and video messages.

4. The method of claim 1, wherein the text messages are accessible on a computer system over the internet.

5. The method of claim 1, wherein the video messages are received on the subscriber's mobile phone device on a text message request to the server.

6. The method of claim 1, wherein the subscriber receives text message before each scheduled food intake and work out exercise of the subscriber.

7. A computer based personal text trainer system for maintaining a sound diet and fitness regimen by sending a text message to a mobile phone device of a subscriber comprising:
at least one main server, the main server includes a plurality of application programs for sending appropriate information to a subscriber through text messages and video messages, the application programs includes a diet application, motivation application, fitness and workout application, reminders application, recipe application and billing application;
at least two interfaces to communicate with the main server, wherein a first of said interface is a mobile telephony network, and a second of said interfaces is by internet connection; and
a database, wherein the database includes a plurality of predefined messages.

8. The personal text trainer system of claim 7, wherein the diet application sends a daily diet plan to the subscriber.

9. The personal text trainer system of claim 7, wherein the motivation application sends predefined motivational text messages to the subscribers.

10. The personal text trainer system of claim 7, wherein the fitness and workout application sends text messages including daily diet and fitness plans to the subscribers as per preset subscriber preference.

11. The personal text trainer system of claim 7, wherein the fitness and workout application sends video messages for teaching recommended exercises and workout activity.

12. The personal text trainer system of claim 7, wherein the reminder application sends reminder text messages to the subscribers as per preset subscriber preferences.

13. The personal text trainer system of claim 7, wherein the billing application sends billing information text messages to the subscribers per subscriber preference.

14. The personal text trainer system of claim 7, wherein the recipe application sends recipe and preparation of recommended food dishes in text messages to the subscribers per subscriber request.

15. The personal text trainer system of claim 7, wherein the recipe application sends recipe and preparation of recommended food dishes in video messages to the subscribers per subscriber request.

16. A method for personal training and maintaining a diet and fitness regimen by sending messages to a communications device of a subscriber, the steps comprising:
subscribing a diet and fitness personal trainer using a communications phone device through a communications network network;
creating a diet and fitness profile of the subscriber;
receiving messages of a new daily diet and fitness plan throughout a day on the subscriber's communications device over the communications network at predefined time hours;
receiving messages of workout, exercise and recipes to the subscriber's communications phone device over the communications network; and
receiving motivational messages on the communications device over the communications network, said motivational messages are for encouraging the subscriber to adhere to the diet and fitness regimen;
receiving a plurality of requests from the subscriber to provide requested information in messages; and
receiving a request for unsubscribing the trainer's service by sending a predefined message request.

17. A system for personal training and maintaining a diet and fitness regimen by sending messages to a communications device of a subscriber, comprising:
a communications phone device for subscribing a diet and fitness personal trainer through a communications network;
a diet and fitness profile of the subscriber;
said communications device adapted for receiving messages of a new daily diet and fitness plan throughout a day on said subscriber's communications device over the communications network at predefined time hours;
said subscriber's communications device receiving messages of work out, exercise and recipe over said communications network; and
said communications device receiving motivational messages on the communications device over said communications network wherein said motivational messages are for encouraging the subscriber to adhere to the diet and fitness regimen;
said communications network receiving a plurality of requests from the communications device of the subscriber to provide requested information in messages; and
said communications device receiving a request for unsubscribing to the trainer's service by said communications device sending a predefined message request.
